(19) United States
(12) Patent Application Publication
(10) Pub. No.: US 2009/0294407 A1
(43) Pub. Date: Dec. 3, 2009

(54) AIR-COOLED COPPER SHOES FOR ELECTROSLAG WELDING APPLICATIONS

(76) Inventor: WILLIAM L. BONG, Walnut Creek, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 12/475,015

(22) Filed: May 29, 2009

Related U.S. Application Data
(60) Provisional application No. 61/058,464, filed on Jun. 3, 2008.

(51) Int. Cl. B23K 25/00

(52) U.S. Cl. 219/73.1

(57) ABSTRACT

Adjustable articulated air-cooled copper welding shoes, capable of being controlled between 800 to 1000 degrees Fahrenheit during Electroslag welding operations, result in faster welds, smaller heat affected zone in the workpieces welded, and less base metal dilution. The shoes thus provide a smaller weld grain structure and stronger bonds in the weld fusion zone.

### CROSS-REFERENCES TO RELATED APPLICATIONS

This U.S. non-provisional patent application is based upon and claims the filing date of U.S. provisional patent application Ser. No. 61/058,464 filed Jun. 3, 2008.

### STATEMENT REGARDING FEDERALLY SPONSORED RESEARCH OR DEVELOPMENT

None.

### REFERENCE TO A MICRO-FICHE APPENDIX

None.

### TECHNICAL FIELD

This invention relates to welding. More particularly, the invention is related to air-cooled copper shoes for use in welding, particularly for Electroslag welding applications including, but not limited to, Arcmatic™ VertaSlag™ welding applications.

### BACKGROUND OF THE INVENTION

Water-cooled copper welding shoes presently used for Electroslag welding applications keep the molten weld metal and flux bath contained in the weld cavity. Water circulates through the copper shoes at a flow rate of approximately 2 gallons per minute. This flow rate is sufficient to keep the copper shoes from melting from excessive heat. In consumable-guide Electroslag welding, the shoes do not move. For longer joints the shoes are repositioned in a leapfrog manner, as welding continues upward. In non consumable guide Electroslag welding the shoes move vertically upward with the vertical rate of rise (VRR) of the molten weld puddle.

Arcmatic™ VertaSlag™ Butt-Weld Water-Cooled Shoes are either cast or machined into the desired shape from pure Oxygen Free, High Conductivity pure Copper (OFHC-101) #101 copper. When cast into shape, the sand mold must provide an interior passage for water flow. A recess (⅛ inch deep by 1 inch wide) is designed into the face of each shoe to shape the weld reinforcement.

Chamfered edges are provided where the copper makes contact with the base material. These chamfered edges help the molten weld metal to wet against the parent material, to provide a smooth transition between the weld metal and the parent material. On conventional water-cooled copper shoes, each shoe has an NPT threaded hole on the input and output for connecting water circulation hose couplings. Internal threaded couplings are attached to the threaded holes and silver-soldered into position to prevent water leaks.

Two relief grooves are cast into the back face of each water-cooled shoe. These relief grooves are to capture a steel, or stainless steel channel that can be attacked to the back of the shoe to reduce wear caused by wedges forced against the back of the shoe. The VertaSlag™ Butt-Weld Shoe is provided in two different sizes: 3 inches wide and 4 inches wide (both available in a variety of lengths.

Arcmatic™ water-cooled Butt-Weld Shoes are used in pairs on either side of the welding joint. When placed against the parent material, cooling water should always enter the copper shoe from the bottom and exit from the top. Water flowing from bottom to top reduces the possibility of “vapor-lock” which could stop the flow of water.

### DISCLOSURE OF INVENTION

To date the welding industry has always used water-cooled copper shoes to make Electroslag welds. The reason for this is that the molten Electroslag flux puddle is at temperatures of approximately 3500 degrees Fahrenheit during the welding operation. The molten steel being welded melts at a temperature of approximately 2300-to-2500 degrees Fahrenheit. Copper melts at approximately 1900 degrees Fahrenheit. If some form of cooling is not applied to the copper, the temperature of the molten flux and molten steel will melt the copper.

Water-cooled Electroslag shoes do an excellent job in keeping the copper from melting. In addition to keeping the copper from melting, some welding engineers think it is necessary to use the water-cooled copper shoes for also keep the parent material from overheating. To accomplish this they want the water-cooled copper shoes to be a minimum of four inches wide for narrow-gap Electroslag welding. The popular theory is that this water-cooled copper shoe width will keep the heat affected zone (HAZ) much smaller, allowing better physical characteristics for a better quality weld. The new addition of narrow-gap Electroslag welding (ESW-NG) to the AWS D1.5 Bridge code requires that the water temperature to-and-from the water-cooled copper shoes be controlled within a very narrow temperature range. To attain this standard requires a very large flow of cold water to maintain the temperature within the narrow limits of the AWS D1.5 code for ESW-NG welding. The problem with this excessive cooling of the base material on either side of the Electroslag weld joint also over chills the temperature of the weld puddle. This over chilling of the weld puddle makes it very difficult to melt the edges of the parent material nearest to the water-cooled shoes. To have the temperature of the parent material high enough to melt the corners of the weld cavity requires excessively high voltage levels. For instance, a typical welding procedure for heavy plate may require 1000-Amps at 38-Volts. Therefore, the total wattage into the weld can be expressed by the product of Amperage times the quotient of Voltage divided by the travel speed. If the weld is traveling at 2 inches/minute, the heat input equation would be expressed as ((1000-Amps×(38-Volts/2 inches/minute))=32-KiloWatts), resulting in the calculated input wattage into the weld.

Arcmatic's “Air-Cooled VertaSlag Butt Welding Shoe™”, uses air to cool the shoe (instead of water) and, thus, allows the copper shoe to heat up to a temperature range of between 800 degrees Fahrenheit to 1000 degrees Fahrenheit. This is possible because the shoe, fittings and plugs are all fusion welded with electron beam fusion welds. If silver solder was used, the solder would melt at a temperature of 1200 degrees Fahrenheit; the fusion weld can heat up to the melting point of copper (approximately 1900 degrees Fahrenheit). If the copper shoes are at a temperature range of between 800 degrees Fahrenheit to 1000 degrees Fahrenheit during the welding operation, the voltage can be substantially lowered and still attain excellent wetting on the edges of the parent material in the weld cavity. This allows the previously mentioned weld to be made at 1000-Amps and 28-Volts (instead of 38-Volts). Another factor that affects the total heat input into the weld is that the high temperature of the air-cooled copper shoe, allows the weld travel speed to be substantially increased. If the travel speed is doubled (say to 4 in/min VRR), the total wattage into the weld would then equal 7 kilowatts (1000×28/4=7-KW) instead of the 32 kilowatts required when welding with water-cooled copper shoes—only 22% of the heat input required by water-cooled shoes.

This massive heat reduction will result in the ability of welding faster, with a smaller HAZ and far less base metal dilution. The base metal dilution of the 38-V weld will require approximately 50% of the base material, while the 28-V weld will require approximately 10-to-20% base metal dilutions. Lower heat input, fastertravel speeds, and lower base metal dilution will result in a smaller grain structure in the weld and a much stronger bond in the fusion zone of the weld.

An embodiment of Arcmatic's new “Air-Cooled VertaSlag Butt Welding Shoe™” uses articulated air-cooled copper shoes to maximize molten weld metal and flux bath containment in the weld cavity and to more completely compensate for alignment differences in VertaSlag™ Electroslag workpieces.

Other features, advantages, and objects of the present invention will become apparent with reference to the following description and accompanying drawings.

These together with other objects of the invention, along with the various features of novelty that characterize the invention, are described with particularity in the claims attached to and forming a part of this disclosure. For a better understanding of the invention, its operating advantages and the specific objects attained by its uses, reference should be made to the attached drawings and descriptive materials in which there are illustrated preferred embodiments of the invention.

### BRIEF DESCRIPTION OF DRAWINGS

These and other features, aspects, and advantages of the present invention will become better understood with regard to the following description, appended claims, and accompanying drawings as further described. Three illustrations are attached to this document.

FIG. 1 is a front elevation view of an embodiment of a representative “Air-Cooled VertaSlag Butt Welding Shoe,™” that is an air-cooled copper welding shoe 10 for Electroslag welding applications showing dual flow channels 20 and 30 of equal cross-sectional area drilled in a copper buss bar 12, inlet and outlet air manifolds 40 and 50, and two plugs 60 and 70.

FIG. 2 is a side elevation view of the embodiment of a representative air-cooled copper shoe 10 of FIG. 1.

FIG. 3 is a top view of the embodiment of a representative air-cooled copper shoe 10 of FIG. 1.

FIG. 4 is a top view of an embodiment of a representative pair of air-cooled copper shoes 10 on either side of an example of an Electroslag weld joint for workpieces 200 and 300 showing the difference in base metal dilution from the heat affected zone 100 for typical water cooled copper shoes and the heat affected zone 90 for the embodiment of a representative pair of air-cooled copper shoes 10.

FIG. 5 is a drawing of the ESW-NG Process showing a side view of the parent material 300, 310, the molten flux puddle 400 and the molten metal puddle 410, along with the location of the guide tube 370 and welding wire 372 in relationship to the molten welding puddles.

FIG. 5A is a detailed section of FIG. 5.

FIG. 6 is schematic of the distributed welding control system 800 for the ESW and ESW-NG welding method and system, including control over the temperature control of the embodiments of air cooled copper shoes, 10 and 200, including the operator's control panel 810 and liquid crystal display (LCD) 820, parallel input and output unit 830, display interface 840, microprocessor control unit 850, operator interface program 852, network interface program 854, system supervisor program 856, and network interface 860.

FIG. 7 is a planar view of the face of the operator control panel 810 of the distributed welding control system 800 of FIG. 6, including the liquid crystal display (“LCD”) 820.

FIG. 8 is an isometric view of an embodiment for articulated air cooled copper shoe 200 from the copper buss bar 212 depicting the threaded air flow channel end 237.

FIG. 9 is an isometric view of an embodiment for articulated air cooled copper shoe 200 from the copper buss bar 212 depicting the threaded air flow channel end 237.

FIG. 10 is an elevation view of an embodiment for articulated air cooled copper shoe 200 depicting chamfered edges 214 of the inside face of the shoe.

FIG. 11 is an elevation end view of an embodiment for articulated air cooled copper shoe 200 depicting chamfered edges 214, air flow channel 220, and connector channels 216.

FIG. 12 is a sectional view of FIG. 9, depicting an air flow channel 220 of an embodiment for articulated air cooled copper shoe 200 middle section with internal snap rings 238.

FIG. 13 is a sectional view of FIG. 8, depicting an air flow channel 220 of an embodiment for articulated air cooled copper shoe 200 end section with internal snap ring 238 on the internal end of the shoe and the threaded air flow channel 237 on the end of the shoe to be connected to the air circulation system.

FIG. 14 is a sectional view of FIG. 8, depicting a connector channel 216 of an embodiment for articulated air cooled copper shoe 200 end section with top and bottom sections, 231 and 232.

FIG. 15 is an isometric view of an embodiment for articulated air cooled copper shoe assembly 200 having four connected copper buss bar sections 212, an inlet manifold connector 240 and an outlet manifold connector 250.

FIG. 16 is a sectional view of the embodiment of FIG. 15 for articulated air cooled copper shoe assembly 200 having three connected copper buss bar sections 212.

FIG. 17 is an exploded view of an embodiment for articulated air cooled copper shoe assembly 200 having two connected copper buss bar sections 212

### BEST MODE FOR CARRYING OUT THE INVENTION

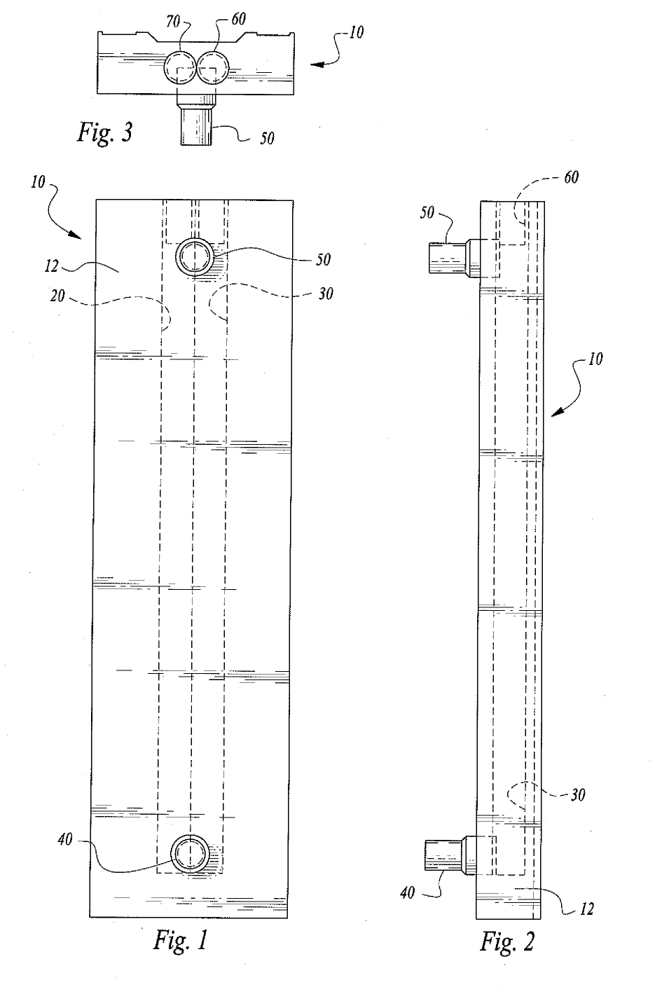

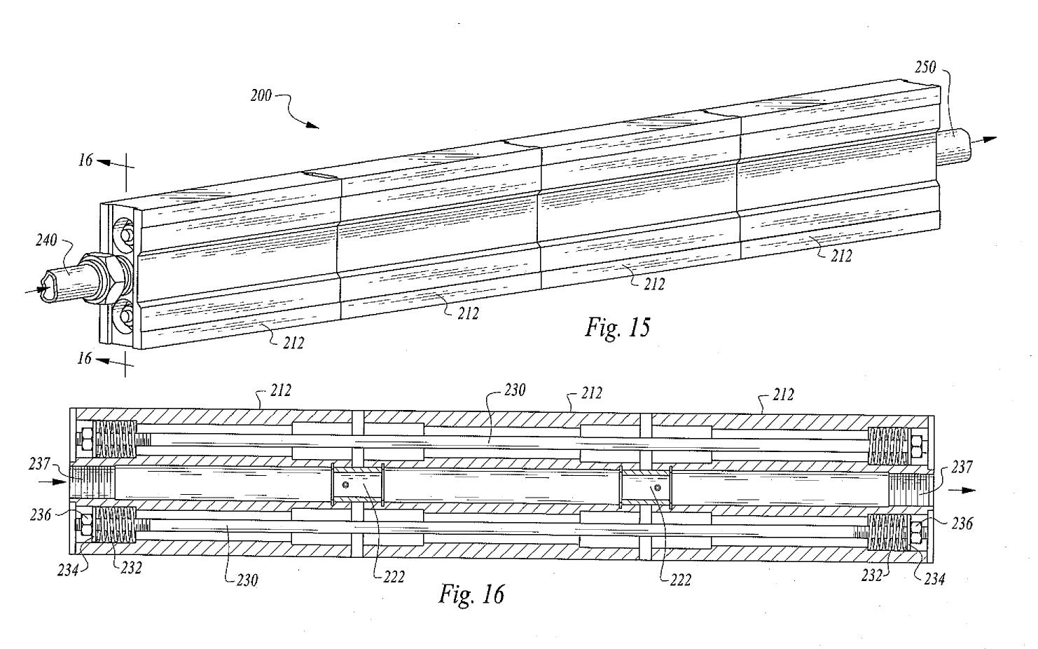

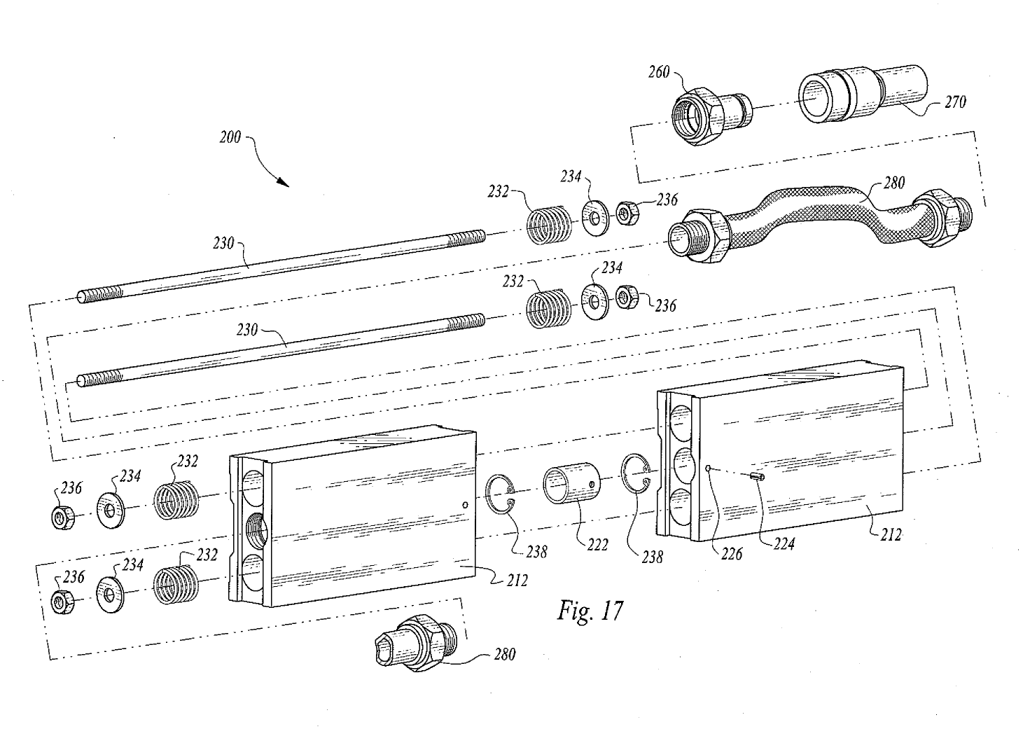

Referring more specifically to the drawings, for illustrative purposes the apparatus for air-cooled copper shoes for application with Electroslag welding systems and methods including, but not limited to, the “Air-Cooled VertaSlag Butt Welding Shoe,™” is embodied generally in FIG. 1-17. It will be appreciated that the system may vary as to configuration and as to the details of the parts, and that the method of using the system may vary as to details and to the order of steps, without departing from the basic concepts as disclosed herein. The apparatus for air-cooled copper shoes for application in Electroslag welding systems and methods is disclosed generally in terms of welding vertical columns, as this particular type of welding operation is widely used. However, the disclosed apparatus for air-cooled copper shoes may be used in a large variety of Electroslag and or Electrogas welding applications, as will be readily apparent to those skilled in the art.

Referring now to FIGS. 1-5, apparatus for air-cooled copper shoes 10 for application in an Electroslag welding system and method in which at least one workpiece 300 and at least one second workpiece 310 are brought together so that a gap 320 exists between each pair of workpieces. The system 10 comprises at least one stationary welding fixture positioned [not shown] to releasably couple with at least one workpiece. The fixture further comprises at least one pair of opposing welding shoes 10 which are placed on each side of each gap 320 to form at least one welding cavity 340.

A welding torch [not shown] is configured to receive at least one consumable guide tube 370 which is placed into the welding cavity 340.

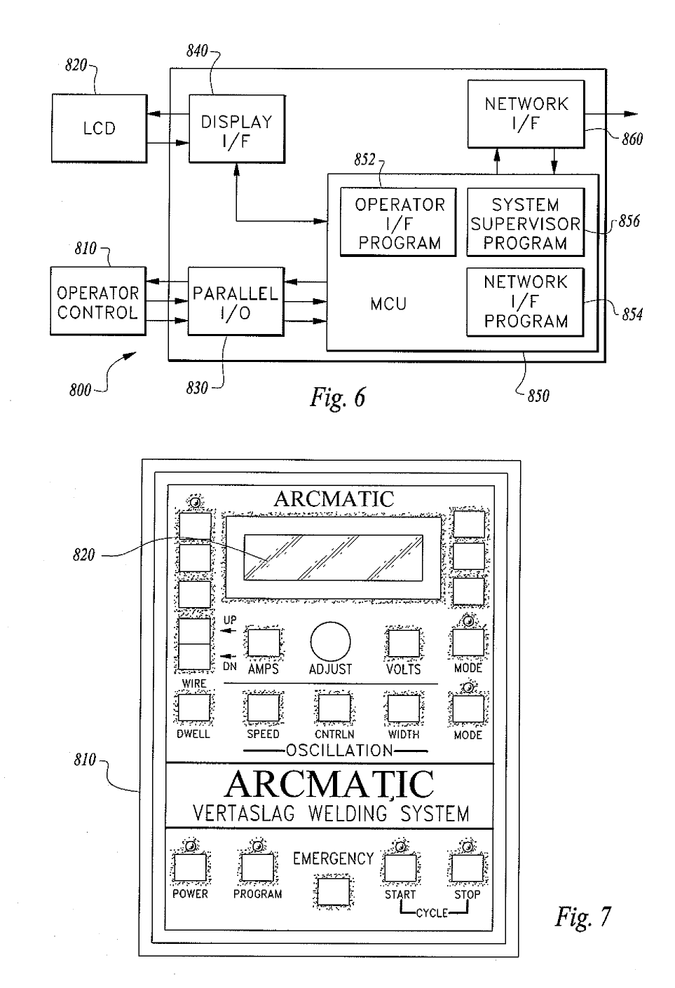

An embodiment of the air-cooled welding shoes 10 including, but not limited to, the “Air-Cooled VertaSlag Butt Welding Shoe,™” and that further comprises a thermally and electrically insulating coating, at least one sump [not shown] adjacent to the bottom portion of each welding shoe pair, and at least one run-off tab [not shown] adjacent to the top portion of each air-cooled welding shoe 10 pair. Each pair of welding shoes 10 comprises copper having means for air-cooled temperature control of the shoes using the Arcmatic™ programmable, computer controlled integrated welding system, FIGS. 6-7.

An embodiment of the system using the air-cooled welding shoes 10 including, but not limited to, the “Air-Cooled VertaSlag Butt Welding Shoe,™” comprises at least one distributed control system, FIGS. 6-7. Each distributed control system, FIGS. 6-7, comprises a plurality of controller modules and a common bus connecting each of the plurality of controller modules, wherein each controller module comprises at least one operator control panel module.

The preferred embodiment of a welding system, in which at least one pair of vertically aligned workpieces, 300 and 310 are brought together so that a gap 320 having a gap center line exists between the workpieces, 300 and 310, comprises: (a) at least one stationary welding fixture [not shown], each fixture comprising means for releasable coupling [not shown] to at least one workpiece, a pair of opposing air-cooled copper welding shoes 10, or articulated air cooled welding shoes 200, placed on each side of the gap 320 to form a welding cavity 340 between the workpieces the shoes, and means for symmetrically positioning the welding shoes 10 adjacent the cavity 340; (b) at least one welding torch [not shown] configured to receive at least one consumable guide tube 370 which is placed into the welding cavity 40, the welding torch coupled to the welding fixture 12 adjacent to each center line; and (c) apparatus comprising: first and second elongated, parallel rotating shafts [not shown]; first and second linear actuators [not shown], the actuators movably mounted on the rotating shafts; means for longitudinally translating the linear actuators along the shafts as the shafts rotate [not shown]; means for sensing movement of the linear actuators [not shown]; and protective housing means [not shown]for enclosing the rotating shafts, the actuators, the longitudinally translating means, and the sensing means, for oscillating each welding torch with the cavity.

The preferred embodiment welding system using air-cooled copper shoes 10 including, but not limited to, the “Air-Cooled VertaSlag Butt Welding Shoe,™” further comprises at least one movable assembly for mounting a welding fixture (not shown), whereby each welding fixture [not shown] is associated with an end of the movable assembly. The welding wire for the preferred embodiment of system for welding comprises between approximately 0.0001% and approximately 0.05% of boron, and between approximately 0.01% and approximately 0.10% of nickel.

The preferred embodiment welding system further comprises at least one flux dispenser [not shown], each flux dispenser comprising: a hopper [not shown]; a rotating belt positioned below the hopper [not shown]; a belt block [not shown] having a recessed area housing the rotating belt; and at least one drop tube [not shown] associated with a lower portion of the recessed area.

The preferred embodiment welding system further comprises at least one welding shoe bottom clamping assembly [not shown], each clamping assembly [not shown] comprising: first and second pairs of air-cooled welding shoes 10; means for positionally adjusting the first pair of air-cooled welding shoes 10 relative to each other; means for positionally adjusting the second pair of air-cooled welding shoes 10 relative to each other; and means for positionally adjusting the first pair of welding shoes relatively to the second pair of welding shoes. The air-cooled welding shoes 10 additionally comprise a thermally and electrically insulating coating (not shown) on at least one face of each air-cooled welding shoe 10.

An embodiment of a representative air-cooled copper shoe 10 including, but not limited to, the “Air-Cooled VertaSlag Butt Welding Shoe,™” for Electroslag welding applications provides dual, side-by-side air flow channels 20 and 30 of equal cross-sectional area drilled in a copper buss bar 12, inlet and outlet air manifolds 40 and 50, and two plugs 60 and 70, FIGS. 1-3. The two plugs 60 and 70 are electron beam fusion welded into the top openings to close the top openings drilled into the copper buss bar 12 to form the dual flow channels 20 and 30. Each inlet and outlet air manifold, 40 and 50, respectively communicates with the flow channels 20 and 30 for counter-current heat exchange air flow relative to the Electroslag welding dynamic.

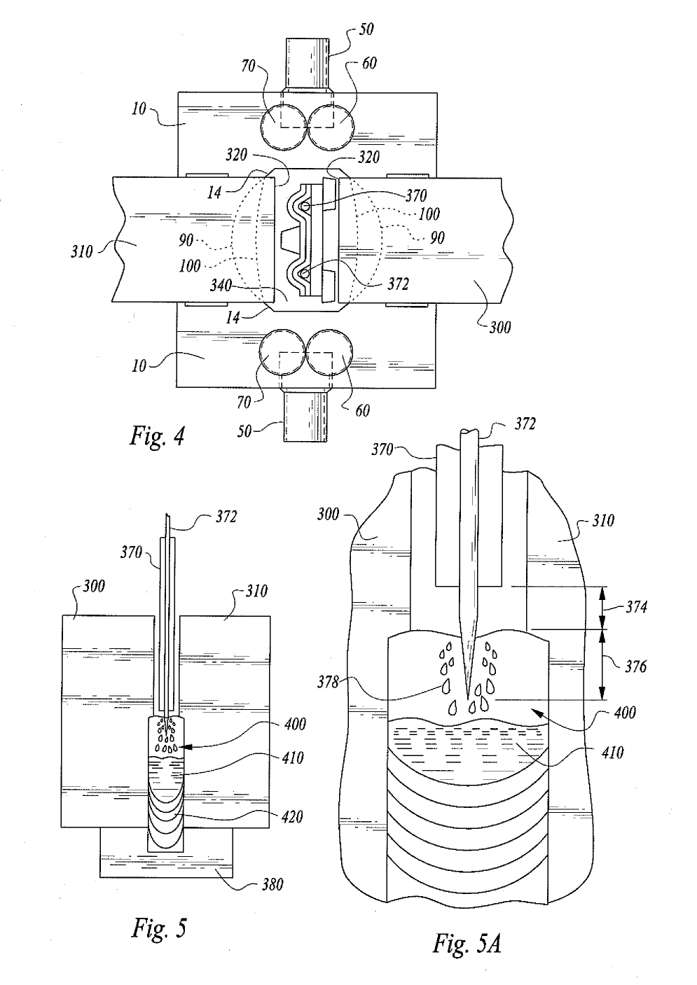

An embodiment of a representative pair of air-cooled copper shoes 10 including, but not limited to, the “Air-Cooled VertaSlag Butt Welding Shoe™” and the embodiment for articulated air cooled copper shoes 200, on either side of an example of an Electroslag weld joint for workpieces 200 and 300 depicts the difference in base metal dilution from the heat affected zone 100 for typical water cooled copper shoes and the heat affected zone 90 for the embodiment of a representative pair of air-cooled copper shoes 10, FIG. 4.

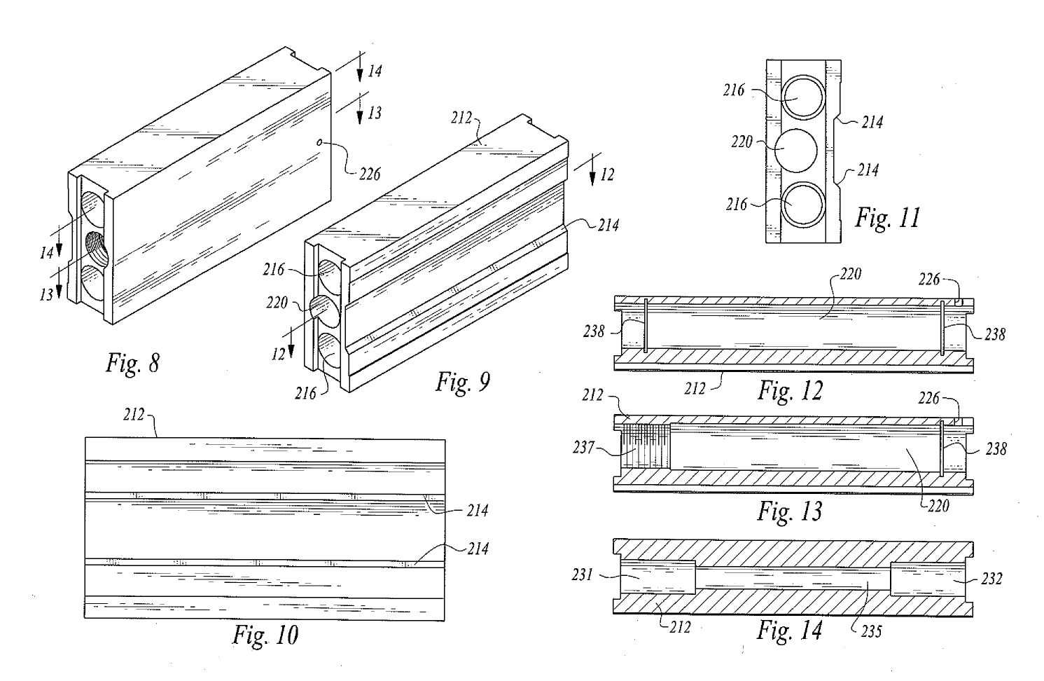

For situations where molten slag containment within the weld cavity, run-off tabs and sump are critical, and the workpieces being welded are not necessarily precisely aligned, such as in welding spliced vertical columns and box columns, an embodiment for articulated air-cooled copper shoes including, but not limited to, the “Air-Cooled VertaSlag Butt Welding Shoe,™” are provided, FIGS. 8-17. It is understood the positioning and adjustment for the articulated air cooled welding shoes is similar to the disclosed positioning and adjustment for the embodiment of air cooled copper shoes 10 described herein.

The embodiment for articulated air-cooled copper shoe assembly 200 for Electroslag welding includes a copper buss bar 212 with a chamfered inside face 214. An airflow channel 220 having a uniform cross-sectional diameter is centered on the longitudinal axis of the copper buss bar and the air flow channel 220 has an inlet air manifold 240 corresponding to the top of the air flow channel 220. An outlet air manifold 250 corresponds to the bottom of the air flow channel. End articulated air cooled copper shoes in the assembly, have a threaded air flow channel end 237, FIGS. 8, 13, 16 and 17. The other air flow channel end for end articulated shoes has a lock ring, 238. Center articulated air cooled copper shoes in the assembly have lock rings 238 in both ends of the air flow channel 220, FIGS. 9, 12, 16 and 17.

Two connector channels 216 of equal length are positioned equidistant from the longitudinal axis of the copper buss bar and the air flow channel 220. Each connector channel 216 includes top and bottom sections, 231 and 233 respectively, having a first uniform cross-sectional diameter and a middle section 235 having a slightly smaller uniform cross-sectional diameter than the top and bottom sections, 231 and 233, and corresponding to the top and bottom sections, 231 and 233, FIGS. 14, 16 and 17. A stainless steel through rod 230 having a uniform cross-sectional diameter and threaded ends is sized to extend through the lengths of the total number of articulated air-cooled copper shoes and has a uniform cross-sectional diameter to fit within the connector channel 216 middle section 235. Each threaded end of the through rod 230 includes a stainless steel spring 232, stainless steel washer 234, and stainless steel locknut 236. The stainless steel spring 232, stainless steel washer 234, and stainless steel locknut 236 are all sized to correspond to the uniform cross-sectional diameter of the top and bottom sections, 231 and 233. The stainless steel washer 234 is sized to correspond to the uniform cross-sectional diameter of the stainless steel through rod 230. The stainless steel locknut 236 has internal threads corresponding to the stainless steel through rod 230 threaded ends. The stainless steel spring 232 provide sufficient expansion tolerance for the articulated air-cooled copper shoe 200 to expand without stretching stainless steel through rod 230 the when the temperature differential is greatest between the copper shoe 200 and the stainless steel through rod 230 during welding operation.

As with the dual air channel copper shoe 10, the articulated air-cooled copper shoe assembly 200 has counter-current air-flow for the VertaSlag welding heat exchange dynamic. In this manner, the inlet air manifold corresponds to the pressurized air flow source through a coupling plug 260, coupling socket 270, and a stainless steel braid hose 280.

Each articulated air-cooled copper shoe assembly 200 air flow channel 220 corresponds to adjacent, connected air flow channels 220 by a stainless steel tube air flow channel insert 222 having a uniform cross-sectional diameter sized to be received and connected to stainless steel internal snap rings 238 in the ends of each air flow channel 220.

The welding process and the welding procedures for air-cooled copper welding shoes 10 and articulated air-cooled copper welding shoes 200 including, but not limited to, the “Air-Cooled VertaSlag Butt Welding Shoe,™” can be pre-programmed into the Arcmatic™ programmable, computer controlled integrated welding system, FIGS. 6-7. The Arcmatic™ distributed welding control system 800 provides fully automatic control over the air-cooled copper welding shoes and related welding process from the operator's control panel 810. The automated control of the air-cooled copper welding shoes components includes a single pendant controller that provides overall system control for a number of discreet motion control networks including microprocessor modular distributed control of each welding torch, each welding torch slide assembly, air circulation through the copper shoes, each wire feed conduit, each high current welding cable, welding power supply, and each Electroslag weld within each welding cavity through a system supervisor program 856, network interface program 854, and an operator interface program 852 of a microprocessor control unit 850. Accordingly, the welding operator for any disclosed method and system of welding using air-cooled copper shoes principally needs to be a skilled operator capable of setting up the weld and running the pre-qualified welding programs The same welding control system and methods used for Arcmatic™ VertaSlag™ welds of the '019 Application and/or the '297 Application, and/or the '472 Patent, the '716 Patent, and/or the '159 Patent, are used to operate and control the method and system of welding including, but not limited to, automating the air-cooled copper shoes “on the job” in the field.

Therefore, the foregoing is considered as illustrative only of the principles of the invention. Additionally, since numerous modifications and changes will readily occur to those skilled in the art, it is not desired to limit the invention to the exact construction and operation shown and described, and further, all suitable modifications and equivalents may be resorted to, falling within the scope of the invention.

I claim:

1. Air-cooled welding shoes for Electroslag welding systems, each air-cooled shoe comprising, in combination:
a) at least one copper buss bar having a forward face, a backward face, a longitudinal central axis, and two ends;
b) at least one air channel within each copper buss bar, each air channel having an upper section and a lower section;
c) at least one air flow intake manifold communicating with each air flow channel upper section;
d) at least one air flow exhaust manifold communicating with each air flow channel lower section;
e) a copper shoe plug capping each air channel upper section; and
f) means for controlling the temperature of the air-cooled shoe during Electroslag welding operation.

2. The air-cooled welding shoes of claim 1, wherein all channels, manifolds, and plugs are fusion welded with electron beam fusion welds.

3. The air-cooled welding shoes of claim 1, further comprising at least one second air channel within each copper buss bar substantially parallel to the at least one air channel, each second air channel having an upper section and a lower section, and wherein the second air channel upper section communicates with at least one air flow intake manifold and the second air channel lower section communicates with at least on air flow exhaust manifold, and wherein the second air channel upper section is capped by a copper shoe plug.

4. The air-cooled welding shoes of claim 1, wherein the temperature of the air-cooled copper shoes is maintained at a temperature range of between 800 degrees Fahrenheit to 1000 degrees Fahrenheit during the Electroslag welding operation.

5. The air-cooled welding shoes of claim 1, wherein each shoe further comprises at least one chamfered edge on the forward face of each copper buss bar.

6. The air-cooled welding shoes of claim 1, wherein the shoes further comprise at least two relief grooves cast into the backward face of each copper buss bar.

7. The air-cooled welding shoes of claim 1, wherein lower and upper air flow manifolds are cast into the backward face of each copper buss bar.

8. The air-cooled welding shoes of claim 1, wherein means for controlling the temperature of the air-cooled shoes comprises at least one distributed control system having at least one controller module for regulating the flow of air through the manifolds and air flow channels of each air-cooled shoe to provide counter-current heat exchange dynamics with respect to the Electroslag welding process.

9. The air-cooled welding shoes of claim 1, further comprising means for connecting at least two shoes to provide an articulated air-cooled welding shoe assembly.

10. The air-cooled welding shoes of claim 9, wherein means for connecting at least two shoes to provide an articulated air-cooled welding shoe assembly comprises, in combination:
a) at least one air channel of uniform cross-sectional diameter along the entire buss bar longitudinal axis, having an open end at both buss bar ends, and having at least one means for receiving and releasably holding a stainless steel tube in one open end;
b) at least two connection channels of even length and having two end portions and a central portion, each connection channel disposed equidistant from and on either side of the air channel, the connection channel central portions having uniform cross-sectional diameters and each connection channel end portion having uniform cross-sectional diameters slightly larger than the connection channel central portions;
c) at least two equal sized connection rods of uniform cross-sectional diameters sized to fit within the connection channel central portion, each connection rod having threaded two ends and a length corresponding to the overall length of articulated welding shoes to be connected by the connection rods;
d) at least one stainless steel tube sized to fit within and be releasably held by means for receiving and releasably holding the stainless steel tube in the air channel open end;
e) means for securing the connection rods to the connection channel end portions of the end shoes of the articulated air-cooled shoe assembly;
f) means for allowing for expansion of the buss bar without stretching the connection rods; and
g) means for providing counter-current air flow through each articulated air-cooled welding shoe assembly.

11. The air-cooled welding shoes of claim 10, wherein means for securing the connection rods to the connection channel end portions of the end shoes of the articulated air-cooled shoe assembly comprises a stainless steel washer having an internal opening sized to receive the connection rod and a stainless steel lock nut having threads sized and corresponding to the connection rod threaded end, and wherein the stainless steel washer and stainless steel lock nut are sized to be received in the connection channel end portion.

12. The air-cooled welding shoes of claim 10, wherein means for allowing for expansion of the buss bar without stretching the connection rods comprises a stainless steel spring sized to correspond to the connection channel end portion diameter, having an internal opening sized to receive the connection rod, and being held in place by the connection channel end portion and means for securing the connection rods to the connection channel end portions of the end shoes of the articulated air-cooled shoe assembly.

13. The air-cooled welding shoes of claim 10, wherein means for receiving and releasably holding a stainless steel tube in one open end comprises an opening in the buss bar backward face and a stainless steel pin sized to securely fit within the opening and communicate with the stainless steel tube within the air channel open end and lock the stainless steel tube in the air channel open end.

14. Air-cooled welding shoes for Electroslag welding systems, each air-cooled shoe comprising, in combination:
a) at least one copper buss bar having a forward face and a backward face, and comprising at least one chamfered edge on the forward face and at least two relief grooves cast into the backward face;
b) at least one electron beam fusion welded, first dual flow air channel within each copper buss bar, each first dual flow air channel having an upper section and a lower section;
c) at least one electron beam fusion welded, second dual flow air channel within each copper buss bar, each second dual flow air channel having an upper section and a lower section;
d) at least one electron beam fusion welded, air flow intake manifold communicating with the first and second dual air flow channel upper sections through the backward face of each copper buss bar;
e) at least one electron beam fusion welded, air flow exhaust manifold communicating with the first and second dual air flow channel lower sections through the backward face of each copper buss bar;
f) an electron beam fusion welded, first copper shoe plug capping each first dual flow air channel upper section;
g) an electron beam fusion welded, second copper shoe plug capping each second dual flow air channel upper section;
h) a source of regulated and controlled circulating air connected to each air flow intake manifold and air flow exhaust manifold; and
h) at least one distributed control system having at least one controller module for regulating counter-current flow of air through the manifolds and air flow channels of each air-cooled shoe for controlling the temperature of the air-cooled copper shoes during Electroslag welding.

15. Articulated air-cooled welding shoes for Electroslag welding systems, each air-cooled shoe comprising, in combination:
a) at least one copper buss bar having a chamfered forward face, a backward face, a longitudinal central axis, and two ends;
b) at least one air channel of uniform cross-sectional diameter along the entire buss bar longitudinal axis, having an open end at both buss bar ends, and having at least one means for receiving and releasably holding a stainless steel tube in one open end;
b) at least two connection channels of even length and having two end portions and a central portion, each connection channel disposed equidistant from and on either side of the air channel, the connection channel central portions having uniform cross-sectional diameters and each connection channel end portion having uniform cross-sectional diameters slightly larger than the connection channel central portions;
c) at least two equal sized connection rods of uniform cross-sectional diameters sized to fit within the connection channel central portion, each connection rod having threaded two ends and a length corresponding to the overall length of articulated welding shoes to be connected by the connection rods;
d) at least one stainless steel tube sized to fit within and be releasably held by means for receiving and releasably holding the stainless steel tube in the air channel open end;
e) a stainless steel washer having an internal opening sized to receive the connection rod and a stainless steel lock nut having threads sized and corresponding to the connection rod threaded end, and wherein the stainless steel washer and stainless steel lock nut are sized to be received in the connection channel end portion and hold the connection rod securely within the connection channel;
f) a stainless steel spring sized to correspond to the connection channel end portion diameter, having an internal opening sized to receive the connection rod, and being held in place by the connection channel end portion and stainless steel washer and stainless steel lock nut;
g) a source of regulated and controlled circulating air connected to each air channel end; and
h) at least one distributed control system having at least one controller module for regulating counter-current flow of air through the air channel(s) of each air-cooled shoe for controlling the temperature of the articulated air-cooled copper shoes during Electroslag welding.
